(19) United States
(12) Patent Application Publication
(10) Pub. No.: US 2002/0065753 A1
(43) Pub. Date: May 30, 2002

(54) Financing of loans

(76) Inventors: Neil Schloss, West Bloomfield, MI (US); Elizabeth S. Acton, Superior Township, MI (US); Malcolm S. Sutherland, Bloomfield Hills, MI (US)

Correspondence Address: David E. Boundy, Shearman & Sterling, 599 Lexington Avenue, New York, NY, 10022, US

(21) Appl. No.: 09/919,532

(22) Filed: Jul. 31, 2001

Related U.S. Application Data
(60) Provisional application No. 60/222,456, filed on Aug. 2, 2000.

(51) Int. Cl. G06F 17/60

(52) U.S. Cl. 705/35

(57) ABSTRACT

A financing enterprise (100) cooperatively owned by at least three originators (110) of financial instruments, no single originator owning 50% or more of the financing enterprise. The originators and financing enterprise cooperatively specify underwriting standards for financial instruments (120). The financing enterprise purchases financial instruments from the originators and aggregates them into pools for resale (130, 132, 140) in the financial markets (102). No single originator has 50% or more representation in any pool. The financing enterprise only purchases financial instruments conforming to the underwriting standards, though the originators are free to originate other financial instruments, and financing enterprise is not bound to purchase all financial instruments tendered by the originators. The financing enterprise may offer the financial instruments in the form of structured securities (140) backed or secured by the financial instruments. The securities include a first loss piece (148). The financing enterprise and securities offered by the financing enterprise are structured to entirely transfer default risk from the originators to purchasers and to terminate the moral recourse obligation historically imposed by rating agencies.

### BACKGROUND OF THE INVENTION

This application claims priority from U.S. provisional application serial No. 60/222,456, filed Aug. 2, 2000.

The invention relates to financial or business practices.

A number of manufacturing companies have established finance companies to assist customers (“customers”) in purchasing manufactured products. For example, Ford Motor Company, General Motors Corporation and DaimlerChrysler have each established wholly owned finance companies (sometimes referred to herein as “captive finance companies”) whose function is to make financing available to customers for the purchase of passenger vehicles, SUV's, light and heavy trucks, fleet sales, etc. (“motor vehicles”). This financing usually takes one of the following forms: (i) the captive finance company makes a direct loan to the customer to purchase the motor vehicle which loan is secured by the motor vehicle, (ii) the captive finance company purchases the motor vehicle from the manufacturer and sells or leases the motor vehicle to the customer pursuant to a retail installment sale agreement or a lease agreement, or (iii) the captive finance company purchases from an automobile dealer a retail installment sale agreement or a lease agreement entered into between the dealer and the customer. The term “financial instruments” includes these loan agreements, retail installment agreements and lease agreements, chattel paper, and similar instruments that arise in financing transactions.

The captive finance companies may hold the financial instruments on their books or may sell the financial instruments to investors, including selling the financial instruments to the financial markets if the form of investment securities backed by or secured by the financial instruments. (The term “financial markets” is generally understood to include public trading exchanges, bond and debt trading venues, private placements, access to these venues mediated by an underwriter or investment bank, sales of financial instruments directly to investors, and other sources from which capital can be raised.) The financial instruments are typically sold to investors under an agreement of sale that disclaims any obligation on the part of the captive finance company, as seller, to cure defaults on the financial instruments by the customers or to repurchase the financial instruments if a default occurs. In most cases, the financial instruments are removed from the seller's balance sheet under generally-accepted accounting principles. Despite these facts, the rating agencies (such as Standard & Poor's, Moody's, and Fitch) that rate the investment securities backed by the financial instruments assume that, if the financial instruments experience greater-than-expected defaults by customers, or if a problem occurs with respect to the investment securities, the captive finance companies, and their parent manufacturing companies, will feel morally obligated to cure the defaults or otherwise resolve the problem with respect to the investment securities, for instance to avoid adverse publicity surrounding failure of an instrument bearing the name of the company. This obligation is often referred to as “moral recourse.” The rating agencies typically impute this moral recourse liability to the finance companies, and require the captive finance companies (and thus the parent manufacturing companies) to maintain appropriate loss reserves and equity to cover greater-than-expected defaults by the customers of the captive finance companies.

GSE's (“government-sponsored entities,” including Fannie Mae, Freddie Mac, Ginnie Mae, and Sallie Mae) purchase or guarantee home mortgages or student loans, aggregate them, and sell them to the financial markets, typically in the form of securities backed by pools of loans. The GSE's provide an insurance wrap or otherwise guarantee the securities, so that the GSE absorbs the first loss caused by default of a borrower.

### SUMMARY OF THE INVENTION

In general, in a first aspect, the invention features a method. Financial instruments are offered for sale in the financial markets. Rating agencies have attributed to an originator of the financial instruments a moral recourse obligation to support the financial instruments. The financial instruments are offered by a financing organization chartered for the purpose of offering the financial instruments in the financial markets. The financial instruments are offered on terms that entirely transfer default risk to purchasers of the financial instruments and that terminate the moral recourse obligation of the originator.

In general, in a second aspect, the invention features a method. Securities are offered for sale in the financial markets, the securities backed by the financial instruments. Rating agencies attribute to an originator of the financial instruments a moral recourse obligation to support the financial instruments. The securities include a first loss piece and are structured to entirely transfer default risk to purchasers of the financial instruments and terminate the moral recourse obligation of the originator.

In general, in a third aspect, the invention features a method. Financial instruments are aggregated and offered for sale in the financial markets, the financial instruments having been originated by a plurality of primary originators. The financial instruments are offered by a financing organization on terms that entirely transfer default risk from the primary originators to purchasers of the financial instruments.

In general, in a fourth aspect, the invention features a method. Financial instruments are aggregated and offered for sale in the financial markets, the financial instruments having been originated by a plurality of primary originators. The financial instruments are offered by a financing organization cooperatively owned by at least three of the primary originators, no single originator of the ownership cooperative owning 50% or more of the financing organization.

In general, in a fifth aspect, the invention features a method. Underwriting standards are specified for a class of financial instruments by a financing organization chartered to offer financial instruments conforming to the underwriting standards in the financial markets. Financial instruments conforming to the underwriting standards are purchased by the financing organization from a plurality of originators of financial instruments. The financing organization is not bound to purchase financial instruments tendered by the originators to the financing organization.

In general, in a sixth aspect, the invention features a method. A cooperative consortium of originators of financial instruments agree to underwriting standards for financial instruments. Financial instruments originated by the originators and conforming to the underwriting standards are aggregated for offering in the financial markets.

In general, in a seventh aspect, the invention features a method. Financial instruments are purchased by a financing organization from a plurality of originators of financial instruments, the financial instruments having been originated at a below-market interest rate. The financing organization receives a cash payment from either a manufacturer of goods financed by the financial instruments or from the originators, the payment being in an amount compensating for the below-market rate.

Embodiments of the invention may include one or more of the following features.

The underwriting standards may be developed in consultation with the rating agencies. The underwriting standards may exclude at least about 25% of financial instruments originated by the originators.

The financial instruments may be purchase money financial instruments to finance purchase of an industry-recognized class of consumer goods, such as automobiles, offered by the originator or a corporate affiliate of the originator. At least two members of the ownership cooperative may be captive finance companies of automobile manufacturers. At least one of the primary originators may not be a member of the ownership cooperative. The financial instruments may be drawn from an industry-recognized class of consumer financial instruments.

The aggregating of the financial instruments may be performed by a financing organization that is independent of the originators. The financing organization may re-underwrite the financial instruments to ensure compliance with the underwriting standards, or audit the financial instruments for compliance with the underwriting standards.

A price paid by the financing organization to the originator may be adjusted based on depreciation rates or resale values of varying models of the goods, and/or based on average credit risk of the borrowers of the financial instruments.

The financial instruments may be organized into pools for sale in the financial markets, the financial instruments backing each pool being held by a bankruptcy-remote entity established by the financing organization. The financing organization may ensure that each pool of financial instruments offered for sale in the financial markets is diversified among the primary originators so that no single originator originated 50% or more of the financial instruments in the pool. Ownership of the financial instruments backing each pool may be transferred into a bankruptcy-remote entity established by the financing organization.

The financial instruments may be offered in the financial markets in at least two of the following forms: (a) whole financial instruments, (b) participations in pools of the financial instruments, and (c) structured securities backed or secured by the financial instruments. The securities may comprise tranches of at least four seniorities.

The originators may be contractually committed not to provide any form of credit support for financial instruments sold by the originator to the financing organization or by the financing organization in the financial markets.

The financing organization may require servicing organizations to service the financial instruments according to specified servicing standards. A master servicing agreement may be entered among the financing organization and the originators under which a master servicing entity provides master servicing services.

The above advantages and features are of representative embodiments only. It should be understood that they are not to be considered limitations on the invention as defined by the claims. Additional features and advantages of the invention will become apparent in the following description, from the drawings, and from the claims.

### DESCRIPTION OF THE DRAWING

FIG. 1 is a transaction flow diagram.

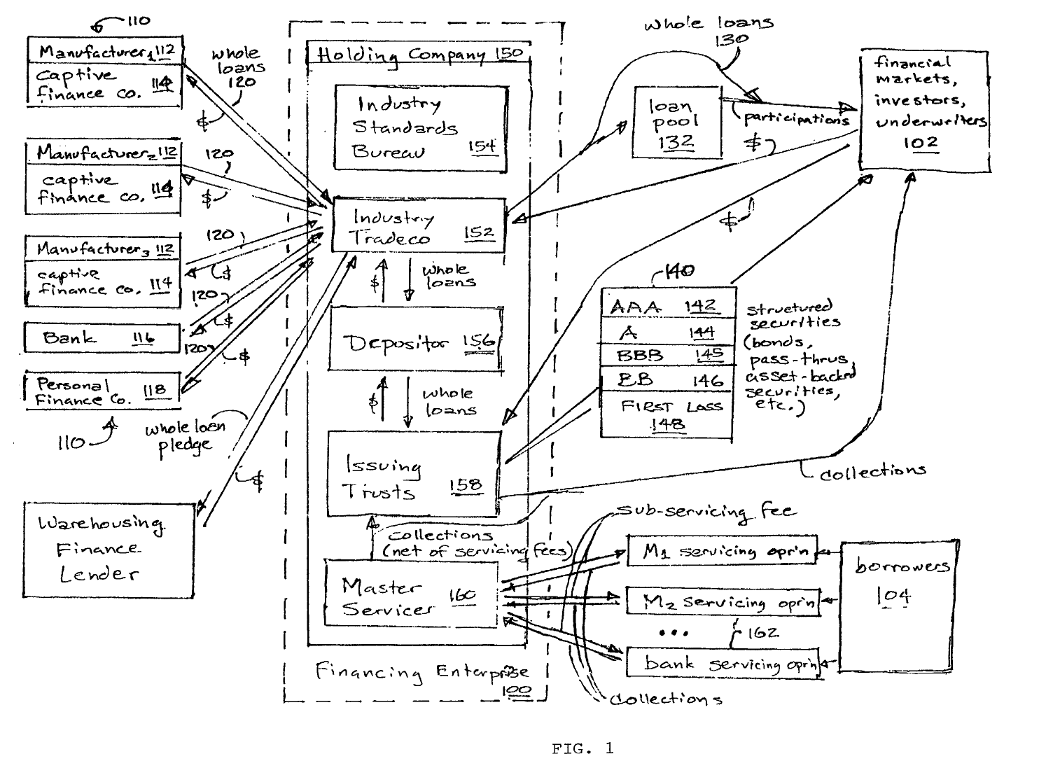

### DESCRIPTION

This disclosure is arranged as follows.

I. I. Overview

II. II. Financing Enterprise

III. Error! Reference source not found.

IV. IV. Financial instruments accepted for purchase

V. V. Securities sold by Financing Enterprise

VI. VI. Internal organization of Financing Enterprise

VI.A. VI.A.Holding Company

VI.B. VI.B.Industry TradeCo

VI.C. VI.C.Industry Standards Bureau

VI.D. VI.D.Depositor

VI.E. VI.E.Issuing Trusts

Vl.F. VI.F.Master Servicer

VI.G. VI.G. Relationship of subsidiaries to Holding Company—tax implications

VII. VII. Origination and sale of financial instruments to Financing Enterprise

VIII. VIII.Loan or lease service

IX. IX. Duties of consortium members to Financing Enterprise 100, and vice-versa

IX.A. IX.A.Deal flow

IX.B. IX.B.Credit scoring model

IX.C. IX.C.Severity

IX.D. IX.D. Tiered pricing

IX.E. IX.E.Geographic factors

IX.F. IX.F.Servicing standards

IX.G. IX.G.Disclosure

I. Overview

Financing Enterprise 100, may be organized under the ownership, direct or indirect, of several manufacturers 112 and other participants, with no one owner having a controlling interest in Financing Enterprise 100. (As will be discussed in section 0, Financing Enterprise 100 per se may have no distinct corporate existence, but may be an assemblage of companies that perform the specific functions described herein.) Financing Enterprise 100 may purchase financial instruments 120 that have been originated or owned by originators 110 of financial instruments, such as the captive finance companies 112, automobile dealers, banks 116 and other consumer finance companies 118. Financing Enterprise 100 may pool the financial instruments 120 and (i) sell the financial instruments 120 in whole instrument sales 130, or sales of participating interests 132 in pools of whole instruments, to investors in the financial markets 102 or (ii) sell structured securities 140 to investors in the financial markets, which investment securities are backed or secured by financial instruments 120. The investment securities 130, 132, 140 may embody all cash flows from repayment of the financial instruments by the customers 104 and may transfer all risk of loss on the financial instruments to the investors.

In alternatives where Financing Enterprise 100 is owned by more than one originator 110, and/or where Financing Enterprise 100 purchases financial instruments 120 from several different originators 110, the investment securities 130, 132, 140 offered to the financial markets may be dissociated from any single originator 110 or manufacturer 112. The sale of financial instruments 120 and investment securities 130, 132, 140 to financial markets 102 may specify that the purchasers 102 of financial instruments 120 and investment securities 130, 132, 140 have no recourse, explicit or implicit, against Financing Enterprise 100, originators 110 or manufacturers 112 for defaults by the customers 104 on the underlying financial instruments 120.

This isolation of investment securities 130, 132, 140 from the financial instruments 120, originators 110 and manufacturers may convince the rating agencies that moral recourse has been “broken,” i.e., that originators 110 and the manufacturers 112 will feel no moral recourse obligation to cure defaults on financial instruments 120 or investment securities 130, 132, 140. If this moral recourse is broken or reduced, the rating agencies may no longer require that loss reserves be maintained by the captive finance companies 114, or their manufacturing company parents 112, or may decrease the amount of such required loss reserves. In either case, significant capital of originators 110 and manufacturers 112 may be freed up, thus enhancing their liquidity and improving their managed equity-to-asset ratios.

II. Financing Enterprise

Financing Enterprise 100 may be organized as a separate bankruptcy-remote corporation (and, as discussed in section 0 below, companies within a holding company) owned, directly or indirectly, by manufacturers 112, their captive finance companies 114, and possibly banks 116 and other unaffiliated finance companies 118. Alternatively, Financing Enterprise 100 may be owned by public shareholders. The individual shareholders of Financing Enterprise 100 may own non-controlling interests in Financing Enterprise 100. The directors and management of Financing Enterprise 100 may be selected to enhance the independence of Financing Enterprise 100 from its direct and indirect shareholders.

Financing Enterprise 100 may develop, maintain and market uniform standards for originating and underwriting conforming financial instruments 120 (“Underwriting Standards”). For example, Financing Enterprise 100 may develop a standard form of contract evidencing financial instruments 120 or standard terms and conditions applicable to certain provisions of financial instruments 120. Financing Enterprise 100 may also develop a standard form of credit scoring model (see section 0) or may use the Fair, Isaac and Co. FICO credit scoring model, and only accept financial instruments 120 that has a FICO score of 700 and above.

Financing Enterprise 100 may audit and re-underwrite financial instruments 120 submitted for purchase, meaning that Financing Enterprise 100 may perform due diligence on financial instruments 120 to insure that they were originated in conformance with the Underwriting Standards 100 and to determine if the representations and warranties made by originators 110 in the contract of sale relating to financial instruments 120 are true. Financing Enterprise 100 may then purchase financial instruments 120 only if they were originated in accordance with the Underwriting Standards.

Financing Enterprise 100 may structure its purchases of financial instruments 120 from originators 110 to achieve portfolio diversification, for example, to ensure that no single originator 110 sells 50% or more of the total volume of financial instruments 120 that flow through Financing Enterprise 100.

Following purchase of financial instruments 120 from originators 110, and preceding its sale to investors, Financing Enterprise 100 may monitor financial instruments 120 and enforce the representations and warranties in the sales agreement relating to financial instruments 120.

Financing Enterprise 100 may pre-qualify and retain servicers 162 of financial instrument 120 under servicing contracts entered into between Financing Enterprise 100 and the servicers 162. In most cases, servicers 162 will be the servicing operations 162 of the originators 110 from whom financial instruments 120 were purchased by Financing Enterprise 100. This pre-qualification of servicers 162 may provide better customer service and may improve collection rates on financial instruments 120, to benefit investors 102.

Financing Enterprise 100 may also serve as a master servicer, as described in section 0, below.

Financing Enterprise 100 may perform marketing and branding functions to increase the demand for financial instruments 120 and the securities 130, 132, 140 that it offers to investors in the financial markets 102 and to facilitate sales of financial instruments 120 and securities 130, 132, 140 to such investors 102. The marketing and branding functions performed by Financing Enterprise 100 may be similar to those of the GSE's.

III. Originator Participants

Originators 110 could include the automobile manufacturers 112 (e.g., Ford Motor Company, General Motors Corporation, DaimlerChrysler Corporation, Honda Motor Company, Nissan Motors Company, and Toyota Motor Company), the captive finance companies 114 of these manufacturers (e.g., Ford Motor Credit Company, General Motors Acceptance Corporation, Chrysler Credit Corporation, Honda Credit Company and Nissan Motors Acceptance Corporation), large volume banks 116 (particularly regional banks), credit unions, internet banks, consumer finance companies 118 that specialize in automobile financing, other sources of financing for those that purchase goods from manufacturers 112, and other originators of qualifying financial instruments. (Other examples could be structured around another class of goods, for instance, computers or agricultural products.)

Originators 110 may each have a non-controlling equity interest in the cooperative corporation 150 that owns Financing Enterprise 100, as discussed further in section 0. The charter of Financing Enterprise 100 may allow Financing Enterprise 100 to purchase financial instruments 120 from both originators 110 who hold an equity interest in the cooperative corporation and originators 110 who have no such equity interest.

Originators 110 may be free to originate financial instruments 120 according to their own underwriting standards, but Financing Enterprise 100 will generally purchase financial instruments 120 from originators 110 only if financial instruments 120 conform to the Underwriting Standards established by Financing Enterprise 100 (see section 0).

Originators 110 may typically sell financial instruments 120 to Financing Enterprise 100 (or to one or another of the subsidiaries of Financing Enterprise 100, see section 0), which may pool and re-sell financial instruments 120 in the financial markets 102. Following the sale, originators 110 may continue to service financial instruments 120 under servicing agreements with the purchaser 102 of financial instruments 120, or may subcontract out servicing, as discussed in sections 0 and 0.

In agreements of purchase and sale relating to financial instruments 120, originators 110 may make certain standard representations and warranties as to financial instruments 120 (e.g., representations as to the condition of the motor vehicle, the status and enforceability of financial instruments 120, and that payments have been timely made), and may, in some cases, be required to restate those representations and warranties when financial instruments 120 are sold to Financing Enterprise 100, and/or to restate them when they are resold to financial markets 102.

IV. Financial Instruments Accepted for Purchase

During the start-up phase for the program, the scope of financial instruments 120 that are sold to Financing Enterprise 100 may be confined to top-tier credits with a low loss history. Top-tier credits provide predictable loss and delinquency characteristics, reduced variability, and predictable prepayment risk. Financing Enterprise 100 may achieve this goal by imposing these requirements in the Underwriting Standards. By focusing on top-tier credits, the servicing requirements related to the master servicing arrangement (discussed in section 0) may be reduced. By focusing on top-tier credits, Financing Enterprise 100 may also be able to increase the volume of financial instruments 120 that are sold to investors, enhance investor interest in the program and improve the development of the investor base.

Each originator 110 may have its own underwriting standards relating to financial instruments 120, above and beyond those relating to credit score. These underwriting standards are implemented to control credit losses. Typical underwriting standards extend a customer's credit score by inquiring into (i) the debt-to-value ratio related to the motor vehicle, (ii) the age of the motor vehicle, (iii) the term of financial instruments 120 (which may vary by credit score, age of vehicle, and vehicle price), (iv) the face amount of the financial instrument 120, (v) the aftermarket accessories (which may vary with the debt related to financial instruments 120 and the type of accessory), and (vi) the existence of insurance and warranty add-ons. These underwriting standards are often similar among originators 110, but details and emphasis may vary among originators 110.

The Underwriting Standards developed by Financing Enterprise 100 may result in only a portion (e.g., 50%, 60%, 65%, 70%, 75% or 80%) of financial instruments 120 originated by a typical originator 110 qualifying for purchased by Financing Enterprise 100. These percentages may be achieved as a consequence of setting the minimum credit score for conforming financial instruments 120. Higher underwriting standards may improve investor acceptance of investment securities 130, 132, 140 of Financing Enterprise 100. However, the Underwriting Standards may be set low enough to not choke off the ability of originators 110 to shift relatively large fractions of their financial instruments 120 off their balance sheets.

The Underwriting Standards specified by Financing Enterprise 100 may not prevent originators 110 from offering financial instruments 120 to their customers that do not conform to these Underwriting Standards, but Financing Enterprise 100 will generally not purchase such non-conforming financial instruments 120. For example, some originators 110 may offer financing plans other than “plain vanilla” financial instruments. Such specialized product offerings include balloon-payment plans, seasonal payment plans (e.g., annual or semi-annual payments for farmers, skipping summer months for teachers), and variable-rate plans. Financing Enterprise 100 may purchase such financial instruments 120 if they meet underwriting standards developed by Financing Enterprise 100 for such specialized instruments, or if Financing Enterprise 100 finds it advantageous to diversify the particular economic profile of an investment security to be offered, or may decline to purchase such financial instruments 120 from originators 110. Financing Enterprise 100 may decide on a consistent set of qualifications it can present to the investor community 102. These qualifications would not prevent originators 110 from offering looser qualifications to their customers, but financial instruments not meeting the Underwriting Standards of Financing Enterprise 100 could not be funded through Financing Enterprise 100.

As Financing Enterprise 100 develops investor interest in the program, it may change the Underwriting Standards to broaden the types of financial instruments 120 it will purchase from originators 110. For example, Financing Enterprise 100 may relax the required credit ratings on financial instruments 120 that it is willing to purchase, may relax the criteria of contract terms for financial instruments 120 that it is willing to purchase. Other variations and sources of diversification may become desirable as the program matures.

Originators 110 will generally not be obligated to sell their financial instruments 120 to Financing Enterprise 100. However, they may find it advantageous to sell their financial instruments 120 to Financing Enterprise 100 since Financing Enterprise 100 may be able to provide financing on more efficient, favorable and flexible terms than originators 110 could realize from their typical financing sources.

V. Securities Sold by Financing Enterprise

Financing Enterprise 100 may sell financial instruments 120 to the financial markets 102 in one or more formats: (i) whole instruments 130, (ii) participations 132 in pools of financial instruments 120, and (iii) structured securities 140 backed or secured by pools of financial instruments 120. Financial instruments 120 backing pools 132 or structured securities 140 may have been acquired from multiple originators 110.

In the case of sales of asset-backed structured securities 140, financial instruments 120 may be transferred to an ownership trust 148 and the trust 148 may issue tranches of senior and subordinate securities. For example, the trust may issue AAA-rated securities 142, AA-rated securities, A-rated securities 144, BBB rated securities 145, BB rated securities 146, and a residual first loss security 148.

By offering financial instruments 120 to financial markets 102 in several different forms, the liquidity of a portfolio of financial instruments 120 may be enhanced. By offering tranched structured securities 140 with different risk characteristics, and/or by offering whole instruments 130, participations 132, and structured securities 140, Financing Enterprise 100 may increase the level of investor interest in financial instruments 120 and investment securities 130, 132, 140. Financing Enterprise 100 may also issue new securities on predictable schedules, for example, monthly, so that investors may have increased choices and opportunities for purchase.

By focusing on high-quality financial instruments 120, the securities offered to the financial markets 102 may attain sufficient uniformity to trade readily on secondary markets. The estimated annual volume of automobile financing instruments repackaged as securities and offered to the financial markets 102 is $30 to $50 billion, with $60 to $100 billion of such securities issued and outstanding at any one time. Though the initial flow of financial instruments 120 through Financing Enterprise 100 may be smaller than this, the enormous size of the market may help a liquid secondary market to emerge relatively quickly. Uniformity and liquidity may improve the efficiency with which financial instruments 120 are sold in the financial markets 102. This should also improve market-based price discovery as well as the price yield to originators 110. Financing Enterprise 100 may also provide an incremental funding source to originators 110.

By offering specialized securities directed to specific investors, Financing Enterprise 100 may expand the choices offered to investors 102, which may attract new investors 102 and improve the prices received by originators 110 for financial instruments 120. The following chart displays two sample offerings. The first column shows the rating of a tranche of securities, and the second column shows the percentage of par value of the entire pool for which the securities of the trance are sold.

| | example 1 - | example 2 - |
|---|---|---|
| rating of the | sales price of the | sales price of the |
| tranche | tranche | tranche |
| AAA | 94% | 93% |
| AA | | 3% |
| A | 3% | |
| BBB | 2% | 2% |
| BB | 1% | |
| B | 2% | |
| unrated, first loss | 1% | 1% |
| Total | 101% | 101% |

In example 1, a pool of financial instruments 120 may have a par value of $200 million. The AAA tranche 142 is sold for $188 million, the A tranche 144 is sold for $6 million, the BBB tranche 145 is sold for $4 million, the B tranche is sold for $2 million, and the unrated first loss security 148 is sold for $2 million. Because each tranche is sold to investors who desire securities at that particular tranche's risk level, the total package of securities can be sold for more than the par value of financial instruments 120. In securitizations of other assets, realizations of 102% and 103% of par value are not uncommon.

The disclosure documentation relating to investment securities 130, 132, 140 may further effect the complete transfer of risk. The offering documents may generally include an explicit disclaimer of any insurance of or recourse on financial instruments 120. Purchasers of investment securities 130, 132, 140 may be required to waive all recourse against originators 110, except for breach of explicit seller representations and warranties in the sale and purchase agreements. This disclaimer of recourse liability and complete risk transfer may enable Financing Enterprise 100 to price the securities in accordance with well-accepted valuation parameters. This risk transfer, coupled with the fact that financial instruments 120 backing pools 132 or structured securities 140 will generally be co-mingled instruments originated by several originators 110, may also eliminate or reduce the moral recourse liability associated with single-originator securitization programs.

The full and complete disclosures made in the offering documents may allow investors 102 to be better informed with respect to the risk characteristics of investment securities 130, 132, 140 and may enable the market to more accurately and efficiently price the securities.

By improving the uniformity and transparency of the documentation and centralizing and standardizing the process for originating and servicing financial instruments 120, Financing Enterprise 100 may reduce the cost and improve the efficiency of the sale of financial instruments 120 to investors in the financial markets. This may increase the price paid to originators 110 for financial instruments 120 as well as well the yields on investment securities 130, 132, 140. Financing Enterprise 100 also serves as a separate issuer, allowing investors 102 to further diversify their investments. By selling investment securities 130, 132, 140 that have repetitive, accepted and well defined terms and conditions, Financing Enterprise 100 may provide originators 110 with greater and more frequent access to the financial markets 102 and a more sustainable investor base.

An example Form S-3 Registration Statement for registering of such investment securities 132, 140 with the Securities and Exchange Commission is included on microfiche in the file of this application. The microfiche are incorporated herein by reference.

Investment securities 130, 132, 140 sold by Financing Enterprise 100 may cover the entire cash flow on financial instruments 120, including the cash flow representing the first loss portion 148 of financial instruments 120. In this case, all payments (net of servicing fees due paid to Financing Enterprise 100 and its affiliates and sub-servicing fees paid to servicers 162) on financial instruments 120 may be paid to investors 102 who purchased investment securities 130, 132, 140. Because the first loss is explicitly incorporated into the first loss securities 148, this arrangement further clarifies that all risk in financial instruments 120 is transferred from originators 110 and Financing Enterprise 100 to investors 102.

Financing Enterprise 100 may arrange its purchases of financial instruments 120 so that financial instruments 120 purchased from a single originator 110 do not represent more than a specified percentage (e.g., 50%) of all financial instruments 120 purchased by Financing Enterprise 100, and/or so that no originator 110 provides more than a specified percentage (e.g., 50%) of financial instruments 120 in any single pool 132 or backing or securing asset-backed structured securities 140. Since most or all pools 132, 140 contain co-mingled financial instruments 120 of several originators 110, no single originator 110 will have the incentive to bear the entire cost of supporting non-performing instruments 120 in pools 132, 140, or to resolve problems related to investment securities 132, 140. This feature may eliminate or weaken any market perception of moral recourse on the part of originators 110.

The incremental cost of selling the entire cash flows on financial instruments 120 (and transferring the risk of non-performance of financial instruments 120) may be more than offset by the reduction in the cost of equity resulting from moving financial instruments 120 off the balance sheet of originator 110. This should improve managed debt-to-equity and managed asset-to-equity ratios, as well as shareholder value.

Originators 110 may be contractually prohibited from providing credit support relating to financial instruments 120 that have been sold to Financing Enterprise 100 or the investment securities 132, 140 backed or secured by financial instruments 120. For example, if originator 110 is a shareholder or a cooperative member of the company that owns Financing Enterprise 100, the by-laws of the corporation may impose this restriction on originator 110.

Each of the techniques described herein may be used separately, or any group may be used in combination. Generally, as more of the techniques are used, rating agencies may allow more reduction in the equity or capital reserve.

Originators 110 may continue to originate financial instruments 120 in much the same way they have traditionally originated financial instruments 120, including through indirect channels. Retail customers 104, dealers and service operations 162 may be relatively affected by the sale of financial instruments 120 to Financing Enterprise 100—each may make and receive payments in the same way they have done in the past. Servicers 162, including originator-owned servicing operations 162, may continue to service all financial instruments 120, including those sold to Financing Enterprise 100. Alternatively, originators 110 may be permitted to contract the servicing function to other servicing entities 162, provided, in the case of financial instruments 120 sold to Financing Enterprise 100, the contracted entity 162 has been pre-qualified by Financing Enterprise 100.

Banks 116 and other finance companies 118 that are not members of the ownership cooperative may be permitted to sell financial instruments 120 to Financing Enterprise 100. They may be attracted to Financing Enterprise 100 since it provides an alternative, and possibly cheaper, source of financing than the financing otherwise available to these entities. The participation of these non-ownership entities in the program may increase the volume and diversity of financial instruments 120 sold through the program, thereby reducing costs to all participants. In addition, the presence of financial instruments 120 originated by these non-ownership entities in the pools 130, 132 and structured securities 140 may contribute to the goal of breaking the moral recourse risk. The market may also significantly benefit from the increased range of choices and competition for the business of financing financial instruments 120.

VI. Internal Organization of Financing Enterprise

Financing Enterprise 100 may consist of a holding company 150 and several subsidiaries. One particular arrangement of parent 150 and subsidiary companies 152, 154, 156, 158, 160 is discussed in this section 0. In other embodiments, Financing Enterprise 100 may be a single corporation, or may have other internal corporate organizations.

VI.A.Holding Company

Holding Company 150 may be organized as a limited liability company (“LLC”) in a pass-through tax structure, for example, as a cooperative under subchapter T of the Internal Revenue Code. A sample Certificate of Incorporation and By-Laws are included on microfiche in the file which is part of this application. The microfiche are incorporated by reference.

Holding Company 150 may be owned by some or all of originators 110, such as the manufacturers 112, their captive finance companies 114, banks, and other finance companies. The membership of the ownership consortium may either be open to all originators 110 or may require the approval of the existing owners. The ownership of Holding Company 150 may be arranged so that an initial public offering (IPO) of Financing Enterprise 100 will be tax neutral—typically this requires that no individual consortium member own, directly or indirectly, more than 50% of the stock of Financing Enterprise 100. Holding Company 150 may be organized as a limited purpose corporation with its organizational charter limiting its business activities. Holding Company 150 may be organized as a “bankruptcy remote entity.” The by-laws or corporate charter of Holding Company 150 may require a super majority vote of shareholders for the corporation to take “extraordinary actions” such as the filing of a bankruptcy petition or the sale of all or substantially all of the assets of the corporation.

Holding Company 150 may be chartered to operate the financing program and securitization activities described above, and may typically operate as a holding company for Industry TradeCo 152, Depositor 156, the Issuing Trusts 158, and/or Master Servicer 160.

Holding Company 150 may be controlled by its members with each member having one vote regardless of its size or the amount of financial instruments 120 it sells to Financing Enterprise 100. In other examples, members that join at different times may have different votes—the initial founding members may have more voting power than members that join later. Holding Company 150 may issue one share of voting common stock to each of its member shareholders, and it may issue additional classes of stock. In most cases, no dividends will be paid on the voting common stock, and dividends on any additional classes stock will not exceed 8% per annum of the issue price of the stock.

Capital may be contributed to Holding Company 150 by its members, and such capital may be recontributed from Holding Company 150 to its wholly owned subsidiaries. Holding Company 150 generally will not incur any debt. Holding Company 150 may pay patronage dividends to its member owners based on the amount of business that the members do with Holding Company 150 and its subsidiaries. For purposes of paying patronage dividends, the amount of business each member does with Financing Enterprise 100 may be determined based upon each member's contribution to the income of Financing Enterprise 100 during the year. Each member's contribution to the income of Financing Enterprise 100 may include the interest income received on the member's financial instruments 120 that are sold to Financing Enterprise 100 as well as the fees collected by Financing Enterprise 100 for services rendered with respect to financial instruments 120. In a liquidation of Financing Enterprise 100, after all of its debts have been paid, financial instruments 120 may be repurchased at their stated value, the stock may be redeemed, and any remaining assets may be distributed to the current and former members on a patronage basis in accordance with their historic patronage over the ten years immediately preceding the liquidation.

Holding Company 150 will generally not be consolidated for tax purposes with any of the member owners, provided that no member owns more than 80% of the value or voting shares of Holding Company 150. If Holding Company 150 is organized as an LLC, its interest and deductions may be attributed to the members on a proportional basis. In most cases, Holding Company 150 will not be consolidated with any member for financial accounting purposes, unless more than 50% of Financing Enterprise 100 is owned by a single member.

VI.B.Industry TradeCo

Industry TradeCo 152 may be a separately organized bankruptcy remote LLC wholly owned by Holding Company 150. The organizational charter or by-laws for Industry TradeCo 152 may limit its activities, for instance to the following activities: (i) the purchase of financial instruments 120 from originators 110, (ii) the sale of financial instruments 120 to Depositor 156, for resale to Issuing Trusts 158, (iii) the sale of financial instruments 120 to investors 102 in whole instrument 130 or participation 132 format, and (iv) the collection and distribution of historical statistics on the performance of financial instruments 120. Industry TradeCo 152 may be managed by a board of directors.

Industry TradeCo 152 may warehouse financial instruments 120 between the time they are purchased from originators 110 and the time that are sold to Depositor 156 or investors 102. While it owns financial instruments 120, Industry TradeCo 152 may finance financial instruments 120 through lines of credit, repo agreements and asset backed commercial paper (ABCP) programs. Industry TradeCo 152 may aggregate financial instruments 120 purchased from originators 110, and may finance financial instruments 120 during the warehousing and aggregation period. Industry TradeCo 152 may hedge and/or manage credit and interest rate risk during the warehousing or aggregation period. Industry TradeCo 152 may make representations and warranties concerning financial instruments 120 to its purchasers, which representations and warranties may apply to the warehousing and aggregation period. Industry TradeCo 152 may re-underwrite financial instruments 120 that it purchases from originators 110 to be sure they conform to the Underwriting Standards.

Industry TradeCo 152 may provide price quotations for the purchase of financial instruments 120 and may negotiate purchases from originators 110. Industry TradeCo 152 may negotiate with underwriters and investors with respect to the resale of financial instruments 120 in the financial markets. Industry TradeCo 152 may also sign sale documents in connection with the sale of financial instruments 120 to Depositor 156 and/or investors 102. Industry TradeCo 152 may coordinate with Industry Standards Bureau 154 concerning the application of the Underwriting Standards established by Financing Enterprise 100.

Industry TradeCo 152 may also monitor and enforce the representations and warranties it receives from originators 110 in the sale agreements signed by originators 110.

Industry TradeCo 152 may enter into the following transaction agreements: (i) sales agreements between originators 110, as sellers, and Industry TradeCo 152, as purchaser, (ii) sales agreements between Industry TradeCo 152, as seller, and Depositor 156, as purchaser, (iii) participation or whole instrument sale agreements with investors 102, as purchasers, (iv) financing agreements with lenders 138 who provide lines of credit to warehouse financial instruments 120, and (v) servicing agreements with servicers 162 (see section 0) of originators 110.

Equity capital for Industry TradeCo 152 may be supplied by Holding Company 150, possibly using a capital guaranty or keep well agreement.

Industry TradeCo 152 may be a wholly owned subsidiary of Holding Company 150 and may be consolidated with Holding Company 150 for tax and financial accounting purposes, assuming that no one member of Holding Company 150 owns more than 50% of the equity capital of Holding Company 150.

Industry TradeCo 152 may collect historical statistics on financial instruments 120. These statistics may be sold to investors 102 and/or originators 110, for example, for use in predict the performance of future financial instruments 120. In some alternatives, only aggregate statistics may be made available, protecting the identity of individual customers 104. The member originators 110 may view much of the information as sensitive competitive information, and thus may opt to restrict sharing of this information between themselves. The nature of information made available to investors 102 may be similarly restricted.

VI.C.Industry Standards Bureau

Industry Standards Bureau 154 may be a separate, bankruptcy remote LLC organized as a wholly owned subsidiary of Holding Company 150. The organizational charter for Industry Standards Bureau 154 may limit its activities to those specified below. In some cases, the activities of Industry Standards Bureau described below may be performed directly by Holding Company 150, rather than Industry Standards Bureau.

Industry Standards Bureau 154 may establish and enforce the Underwriting Standards with respect to financial instruments 120 and the qualification of originators 110 and servicers 162 for financial instruments 120. These Underwriting Standards may be developed in consultation with originators 110, particularly those originators 110 that are member/owners of Holding Company 150, and in consultation with Industry TradeCo 152, the underwriters of structured securities and the rating agencies. Industry Standards Bureau 154 may consult with underwriters and rating agencies concerning credit enhancement methodologies. Industry Standards Bureau 154 may also set the pricing for all Industry TradeCo 152 and Depositor 156 transactions. Industry Standards Bureau 154 may audit financial instruments 120 to ensure that they meet the Underwriting Standards. In this case, it may audit for loan file tape-to-file integrity or for the accuracy of the flow-through representations and warranties made by originators 110 in the instrument sale agreements. Industry Standards Bureau 154 may re-underwrite financial instruments 120 or may re-underwrite aggregated pools 132, 140 of financial instruments 120. Industry TradeCo 152 may also review the disclosure made in the offering documents for securities sold by Financing Enterprise 100.

Industry Standards Bureau 154 may provide certain marketing and branding functions for Financing Enterprise 100, such as disseminating market information concerning financial instruments 120 and the financial markets and educating originators 110 and investors 102 concerning the functions of Financing Enterprise 100 and the advantages of selling financial instruments 120 to Financing Enterprise 100. Industry TradeCo 152 may establish a licensing framework for originator benchmark data and for underwriting systems. Industry Standards Bureau 154 may obtain rights with respect to any copyrights and/or patents that are required for the operation of Financing Enterprise 100.

Industry Standards Bureau 154 may be funded through bank lines or advances from Holding Company 150.

Industry Standards Bureau 154 may be a wholly owned subsidiary of Holding Company 150 and may be consolidated with Holding Company 150 for tax and financial accounting purposes, assuming that no one member of Holding Company 150 owns more than 50% of the equity capital of Holding Company 150.

The existence and independence of Industry Standards Bureau 154 may enhance the markets' perception of Financing Enterprise 100 as a separate corporation that is independent of originators 110 and the manufacturers, and as a neutral developer and enforcer of the Underwriting Standards. This may help eliminate or reduce the moral recourse risk. Industry Standards Bureau 154 could be organized as a separate corporation that is independent of Holding Company 150, which may further reduce the moral recourse risk.

VI.D.Depositor

Depositor 156 may be a bankruptcy remote LLC organized as a wholly owned subsidiary of Holding Company 150. The organizational charter for Depositor 156 may limit its activities to those specified below. In some cases, the functions of Depositor 156 may be performed directly by Holding Company 150.

Depositor 156 may serve as the sponsor of the investment securities 130, 132, 140 and as the registrant for the shelf registration statement for the investment securities 130, 132, 140 to be offered for sale to the investors. Depositor 156 may purchase financial instruments 120 from originators 110 or Industry TradeCo 152. Depositor 156 may organize the Issuing Trusts and may sell financial instruments 120 to the Issuing Trusts 158 immediately after they are acquired by Depositor 156.

Depositor 156 may enter into the following agreements: (i) purchase agreements between Depositor 156, as purchaser, and originators 110 and Industry TradeCo 152, as sellers, (ii) sale agreements between Depositor 156, as seller, and Issuing Trusts 158, as purchaser, (iii) underwriting agreements between Depositor 156 and the underwriters of investment securities 130, 132, 140, (iv) trust agreements with Issuing Trusts 158, and (v) servicing agreements between Depositor 156, Master Servicer 160, and the Issuing Trusts 158.

Depositor 156 may be a wholly owned subsidiary of Holding Company 150 and may be consolidated with Holding Company 150 for tax and financial accounting purposes, assuming that no one member of Holding Company 150 owns more than 50% of the equity capital of Holding Company 150.

VI.E.Issuing Trusts

Issuing Trusts 158 may be organized as trusts to hold financial instruments 120 during the life of pools 132 or structured securities 140. Issuing Trusts 158 may hold financial instruments 120 for only an instant in time, simultaneously purchasing them from Depositor 156 or Industry Tradeco 152 and selling investment securities 130, 132, 140 to finance the purchase. Issuing Trusts 158 may be the issuers of structured securities 140.

In some cases, Issuing Trust 158, Depositor 156, or Industry Tradeco 152 may sell investment securities 130, 132, 140 to underwriters, and the underwriters will, in turn, sell investment securities 130, 132, 140 to investors in the financial markets 102.

VI.F.Master Servicer

Master Servicer 160 may be organized as a bankruptcy remote LLC, wholly owned by Holding Company 150. The organizational charter of Master Servicer 160 may limit its activities to those specified below, and the operations of Master Servicer 160 may be governed by a board of directors. Master Servicer 160 may be a wholly owned subsidiary of Holding Company 150 and may be consolidated with Holding Company 150 for tax and financial accounting purposes, assuming that no one member of Holding Company 150 owns more than 50% of the equity capital of Holding Company 150. In some cases, the functions described below for the Master Service 160 may be performed directly by Holding Company 150.

Alternatively, Master Servicer 160 may be organized as a corporate entity separate and independent from Holding Company 150 and Financing Enterprise 100, in which case it may be owned by a consortium of owners similar to the ownership of Holding Company 150.

Master Servicer 160 may have primary responsibility for servicing financial instruments 120 and may serve as an intermediary between the investors 102 and the servicers 162 who customarily service financial instruments 120 for originators 110 (see section 0). Master Servicer 160 may retain these servicers 162 as sub-servicers of financial instruments 120 and may coordinate the activities of these sub-servicers 162. Master Servicer 160 may also collect and aggregate information concerning payments on financial instruments 120 and other performance characteristics of financial instruments 120, and may generate monthly servicing statements for originators 110, the Issuing Trusts 158 and/or the investors 102. Master Servicer 160 may also collect and redistribute fee income among the subsidiaries of Holding Company 150.

Master Servicer 160 may enter a master servicing agreement with Industry TradeCo 152, Depositor 156 and the Issuing Trusts 158. Master Servicer 160 may enter sub-servicing agreements with captive finance companies 114 or other servicing companies or operations 162.

In some cases, Master Servicer 160 may be a qualified master servicer owned by a third party, and may be funded with substantial start-up capital from that third party.

Master Servicer 160 may also directly service financial instruments 120 owned by Depositor 156 or financial instruments 120 owned by the investors 102 in whole instrument 130 or participation form 132.

VI.G. Relationship of Subsidiaries to Holding Company—Tax Implications

Industry TradeCo 152, Industry Standards Bureau 154, Depositor 156, and Master Servicer 160, which may be LLC's wholly owned by Holding Company 150, may be treated for tax purposes as disregarded entities so that their activities may be ascribed to Financing Enterprise 100. In this case, all items of income and expense incurred by these subsidiaries 152, 156, 160 may be treated as income and expense of Financing Enterprise 100, and all business transacted by the members with these companies may be business transacted with Financing Enterprise 100 for purposes of making patronage distributions to the members/owners of Financing Enterprise 100. Since the companies may be wholly-owned by Holding Company 150, they may be disregarded entities for federal income tax purposes, and their income, expenses, assets, liabilities and activities may be ascribed to Holding Company 150.

The income and expenses incurred as part of the warehousing, securitization, and collection processes of Industry TradeCo 152 and Depositor 156 may be an integral part of the financial services provided to member originators 110, and may be patronage sourced. These include (i) the interest expense on borrowings to finance the purchase of financial instruments 120 by Industry TradeCo 152, (ii) the interest income collected on financial instruments 120 temporarily held by Industry TradeCo 152 during the warehousing and consolidation period prior to their sale to investors, (iii) the servicing fees and expenses associated with the registration of investment securities 130, 132, 140 with the SEC by Depositor 156, and (iv) the servicing fees and expenses associated with the collection of financial instruments 120 by Master Servicer Master Servicer 160.

Payment of patronage dividends based on the amount of income earned on financial instruments 120 transferred to Financing Enterprise 100 by originators 110 who are members of Financing Enterprise 100, plus any fee income earned by providing services with respect to the transferred financial instruments 120, may be treated as a distribution based on the quantity or value of the business done for, or with, the members under Section 1388 (a) (1) of the Internal Revenue Code.

Amounts paid to members as patronage dividends during the taxable year and within eight and one half months after the close of the taxable year may qualify as being paid during the payment period for paying patronage dividends.

VII. Origination and Sale of Financial Instruments to Financing Enterprise

When an originator 110 originates a financial instrument 120, it may: (i) temporarily hold financial instrument 120 for future sale to Financing Enterprise 100 and finance financial instrument 120 with funds from existing credit sources, (ii) sell financial instrument 120 to Financing Enterprise 100 for resale to investors 102, (iii) sell financial instrument 120 to investors 102 in a transaction arranged by Depositor 156 or Industry TradeCo 152, or (iv) sell financial instrument 120 directly to Depositor 156 for resale to an Issuing Trust 158. Industry TradeCo 152 may warehouse financial instrument 120 for a time, either through self-financing or through conventional commercial financing arrangements, while financial instruments 120 are aggregated and pooled for ultimate sale to investors as whole instruments 130 or as investment securities 132, 140 backed or secured by financial instruments 120. Financing Enterprise 100 may hedge and manage credit and interest rate risk during the warehousing period. If a financial instrument 120 is held by originator 110, originator 110 may continue to finance financial instrument 120 through traditional financing sources, for example, by factoring, bank lines, or sales to investors 102 in a single-originator securitization program, or any other alternative that originator 110 finds convenient and economical, and that are not barred by negative pledges in the debt covenants.

If financial instrument 120 is warehoused by originator 110, interest income on financial instrument 120 and interest expense on the debt incurred to finance financial instrument 120 may be reflected on the consolidated tax returns of the manufacturer 112 if the originator is a captive finance company 114. If the manufacturer 112 or originator 110 ultimately holds the first loss position on any of the securities sold by Financing Enterprise 100 to investors 102, the manufacturer 112 or originator 110 may be required to include a proportionate ownership interest in the transferred financial instruments 120 on its consolidated tax return. Financial instruments 120 may be included on its balance sheet for FASB accounting purposes.

If the manufacturer 112 subsidizes financial instruments 120—for example, by offering below-market financing for the purchase of certain models of motor vehicles—originator 110 may be required to make a payment to Financing Enterprise 100 to cover the subsidy, so that the sum of the payments received from the purchaser 104 of the motor vehicle together with the subsidy yield a market rate of return on financial instrument 120.

Originator 110 may monitor its financial instruments 120 to ensure that they meet the Underwriting Standards developed by Industry Standards Bureau 154 (see section 0)

The captive finance company 114 may typically be consolidated with other subsidiaries of the manufacturer 112 for tax and financial accounting purposes.

An originator's participation in Financing Enterprise 100 may reduce its absolute pre-tax profits because of the fees that are paid out to Financing Enterprise 100 and servicers 162. However, this may be accompanied by a reduction in the underlying capital requirements and loss reserves that must be held by originator 110. This should improve the originator's after tax return on equity and shareholder value. The originator's ownership interest in Financing Enterprise 100 may provide member originators 110 with potential fee income from other non-shareholder originators 110, for example banks, internet companies and the like.

Because Financing Enterprise 100 offers originators 110 a ready access to the financial markets 102, the originator's liquidity may be significantly improved. The manufacturing company 112 should find that less equity must be committed to its financing business, which may free up capital for other uses.

Although the originator's ownership interest in Financing Enterprise 100 may slightly reduce the income of originator 110 because of the risk premium paid in the sale of financial instruments 120 and investment securities 132, 140 to investors in the financial markets 102, the overall ratio of income to equity may be improved and shareholder value may therefore be enhanced.

VIII.Loan or Lease Service Operations

In many cases, originators 110 may have existing servicing operations 162 to service their financial instruments 120. Under the program, these servicing operations 162 may remain essentially undisturbed, performing their conventional functions with relatively minor modification. The existing servicing operations 162 of originators 110 may continue to function as the primary servicers of financial instruments 120 sold to Financing Enterprise 100. These servicers 162 may operate under sub-servicing contracts entered into with Master Servicer 160.

Originators 110 that do not have servicing operations 162 that meet the standards set by Financing Enterprise 100 may contract out the servicing functions to other member servicing operations 162 that meet these standards and have been qualified by Financing Enterprise 100.

IX. Duties of Consortium Members to Financing Enterprise 100, and vice-versa

In the context of financing automobile financial instruments through Financing Enterprise 100, the following considerations may enter into framing the contractual relationships among Financing Enterprise 100, investors 102, originators 110, and service companies 162.

IX.A.Deal Flow

Financing Enterprise 100 may require originators 110 to commit to sell a certain volume of financial instruments 120 to Financing Enterprise 100—e.g., to tender a given percentage of their prime financial instruments 120. Ownership of Financing Enterprise 100 may be proportional to transaction volume by the members who form Financing Enterprise 100, and later members may not be offered a full equity membership in Financing Enterprise 100.

IX.B.Credit Scoring Model

Financing Enterprise 100 may base the Underwriting Standards, at least in part, on a credit scoring model. A credit scoring model asks the customer a number of questions and reduces the answers to one number, or to a few numbers, that allows originator 110 to assess the creditworthiness of the customer.

A more detailed credit scoring model has several advantages, including better predictability of default, and, in a statistical sense, better market execution for Financing Enterprise 100.

Less detailed credit scoring models also have advantages in that they require fewer changes by originators 110 to meet the requirements of the model—the more detailed credit scoring models may require originators 110 to collect data that they do not currently collect from customers. Originators 110 may be more willing to enter into relationships with Financing Enterprise 100 if Financing Enterprise 100 adopts a simpler credit scoring model because originators 110 may be reluctant to ask their customers these more detailed questions.

In general, it may be preferable for Financing Enterprise 100 to use a less detailed credit scoring model, possibly with only ten to fifteen variables, particularly in arrangements that target only high quality customers 104: if a few questions suggest that a customer 104 has a high credit score, the information gained by asking additional questions may not reduce the lender's risk sufficiently to overcome the disadvantages of asking the additional questions. If Financing Enterprise 100 elects to finance lower credit financial instruments 120, Financing Enterprise 100 may use a more detailed credit scoring model with many more variables.

Originators 110 may continue to originate financial instruments 120 in accordance with their current credit scoring models. When financial instruments 120 are offered to Financing Enterprise 100, Financing Enterprise 100 may apply its own credit scoring model to determine which financial instruments 120 to purchase and what price to pay for financial instruments 120.

IX.C.Severity

Credit losses are determined by two factors: default frequency and severity. Loss severity is the average loss per default on financial instruments 120, or the difference between the amount owed on a defaulted financial instruments 120 and the sales proceeds from any sale of the repossessed motor vehicle. In the automobile loan market, severity tends to remain fairly consistent over time, but varies with several other factors. A higher debt-to-value ratio tends to increase loss severity. Loss severity also varies with the economic cycle, the type and model of the motor vehicle, whether the motor vehicle was a new or a used motor vehicle when it was sold to the customer, and the resale demand for used vehicles.

To a certain extent, the debt-to-value ratio and the term of financial instruments 120 can be controlled through the credit scoring model and the Underwriting Standards established by Financing Enterprise 100. The economic cycle is one of the risks incorporated into the credit scoring model and is one of the risks that investors 102 (particularly the first-loss or interest-only strip investors) assume.

Since most (or all) of the member/owners of Financing Enterprise 100 will finance less than their entire portfolio of conforming financial instruments 120 through Financing Enterprise 100, they will have discretion in their selection of which financial instruments 120 to finance. Originators 110 may have an incentive to disproportionately sell Financing Enterprise 100 financial instruments 120 secured by motor vehicles with low projected resale values and retain ownership of financial instruments 120 related to motor vehicles that hold their value. Financing Enterprise 100 may regulate this adverse selection by requiring financial instruments 120 submitted to Financing Enterprise 100 to be based on a random selection of all conforming financial instruments 120. This may substantially increase auditing complexity. Originators 110 have some incentives not to adversely select financial instruments 120 for sale to Financing Enterprise 100 since they have an economic incentive to support Financing Enterprise 100 and, in the case of some originators 110, may have an indirect ownership interest in Financing Enterprise 100 as a result of their ownership interest in Financing Enterprise 100.

Financing Enterprise 100 may attempt to prevent adverse selection by requiring originators 110 to agree to offer only baskets of financial instruments 120 that fairly reflect the total portfolio of financial instruments 120 originated by the originator.

Alternatively, Financing Enterprise 100 may set different pass-through rates with respect to the proceeds from investment securities 130, 132, 140 based on differences in expected resale values of the motor vehicles. Based on publicly-available actual and projected resale values (based, for example, on the statistics gathered by the Industry Standards Bureau 154), Financing Enterprise 100 may adjust the prices paid to originators 110 to account for differences in expected credit losses or other differences in asset quality. In some cases, this risk may not be completely mitigated, however, since manufacturers 112 will nearly always have some advantage based on their unique knowledge of cycle plans, motor vehicle quality, and planned recalls with respect to the motor vehicles.

This same procedures can be used to set different qualifying cutoffs for motor vehicle lines in an attempt to equalize the expected losses among all motor vehicle lines. This alternative, however, may add significant complexity in explaining the plan to investors. To align the incentives of Financing Enterprise 100 and the manufacturers 112, Financing Enterprise 100 may set cutoff and average default rate limits.

IX.D. Tiered Pricing

Another source of adverse selection for Financing Enterprise 100 could result from a one-rate policy for financial instruments 120, regardless of risk. If Financing Enterprise 100 accepts financial instruments 120 up to an 8% default rate, annualized credit losses could range from virtually 0, on the best financial instruments 120, to 120 basis points or more, for lower quality financial instruments 120.

Like the GSE's, Financing Enterprise 100 attempts to achieve a consistent blend of credit risk to meet market expectations. Unlike the GSE's, however, Financing Enterprise 100 may not have the resources to keep financial instruments 120 on its balance sheet in order to achieve this objective—instead it may try to manage the flow of financial instruments 120 to maintain consistency.

While the larger originators 110 may feel some responsibility to maintain the quality of financial instruments 120 offered to Financing Enterprise 100, smaller originators 110, particularly those with no equity interest in Financing Enterprise 100, may be tempted to free-ride on the others by dumping higher-risk financial instruments 120 to Financing Enterprise 100. In addition, some originators 110 may have origination policies that are different, and less exacting, than the average. Over time, these differences could cause some originators 110 to drop out of the program if they feel that they are subsidizing other originators 110 in this fashion.

Financing Enterprise 100 may address these adverse selection issues in one or more ways.

In some cases, Financing Enterprise 100 may monitor financial instruments 120 offered to detect this form of free-riding, or dumping of lower-quality financial instruments 120.

Financing Enterprise 100 may set the price it pays to originators 110 based, at least in part, on the credit score of financial instruments 120 offered by originators 110. For example, a basket of financial instruments 120 that has FICO scores uniformly distributed over the range of 700-850 may receive a higher price than a basket of financial instruments 120 having FICO scores clustered in the 700-705 range. In some cases, the price may be posted by Financing Enterprise 100 so that originators 110 know in advance the price that will be offered for financial instruments 120; in other cases, Financing Enterprise 100 and originators 110 may engage in an arms-length negotiation to price each offering of financial instruments 120.

If financial instruments 120 from an originator 110 demonstrate poor performance or greater-than-expected variations, Financing Enterprise 100 may refuse future purchases from that originator 110.

IX.E.Geographic Factors

In the mortgage market, some geographical areas are known to have higher prepayment risk than others. This difference is factored into the pricing of the GSE's. Similarly, in the automobile loan market, anecdotal evidence suggests that customers in some areas of the country prepay their loans at higher rates than customers in other areas. Financing Enterprise 100 may reflect this varying prepayment risk in the prices paid for financial instruments 120. Financing Enterprise 100 may also seek regional diversification of financial instruments 120 to reduce this variability in prepayment risk.

In some markets, lenders exclude contracts from certain states (for example, Alabama and Pennsylvania) from their securitization programs for administrative reasons. Similarly, finance Company 100 may exclude financial instruments 120 from these states, or may discount the purchase price paid for financial instruments 120 originating from these states.

IX.F.Servicing Standards

Servicing includes payment processing, collection of past-due amounts, extensions, the exercise of remedies such as repossession, and loan charge offs. Although the basics of servicing are the same, different servicers 162 may have different servicing standards. For example, while some servicers 162 allow payment due dates to fall on any day of the month, others have one due date (often the first or second day of the month, to minimize reported delinquency). There are also differences in the quality of payment processing which affects the misapplication of payments.

Collection practices also vary among servicers 162. Differences in collection practices include sending computer-generated notices, the decision to begin telephone follow-up, and the use of predictive scoring models to prioritize telephone activity. On seriously delinquent accounts, servicers 162 can differ on when to declare a financial instruments 120 uncollectable and when to begin the repossession or charge-off process.

In addition, the use of extensions as a collection technique varies widely among servicers 162. Some servicers 162 have programs to offer extensions to non-delinquent customers periodically. This practice may be unacceptable to investors 102, who would find their principal payments unexpectedly delayed.

Another servicing technique that likely would be unacceptable to Financing Enterprise 100 and investors is the practice of soliciting customers with positive equity in their motor vehicles to prepay the loan and purchase another motor vehicle. The potential negative impact on originators 110 of eliminating this practice may need to be taken into account when evaluating the program.

Investors 102 will have a strong interest in the quality of the servicing. As a result, Financing Enterprise 100 may develop servicing standards that must be applied to financial instruments 120 it purchases. Initially, most large originators 110 may want to provide their own servicing with respect to financial instruments 120 they sell to Financing Enterprise 100. With certain exceptions (such as widespread extension programs), the existing servicing practices of originators 110 are likely to meet the standards set by Financing Enterprise 100. Some originators 110, typically smaller originators 110, may need to change their standards in order to meet these servicing standards. Alternatively, these originators 110 may outsource the servicing of their loans and/or leases sold to Financing Enterprise 100, in which case they would contract with a servicer 162 pre-qualified by Financing Enterprise 100.

To assure the uniform servicing of financial instruments 120, the agreements entered into between originator-owned servicing operations 162 and Financing Enterprise 100 may specify that the servicers 162 not be informed as to which financial instruments 120 have been sold to Financing Enterprise 100 and which remain owned by originators 110.

IX.G.Disclosure

The offering documents with respect to investment securities 130, 132, 140 may include significant disclosures concerning (i) financial instruments 120 in the investment pool (e.g., the percentage of value or units by manufacturer or individual motor vehicle model), (ii) the customers (e.g., statistics conveying aggregate credit scoring and credit history), and (iii) the characteristics of financial instruments 120 backing the pool.

### Reference to Microfiche

This disclosure includes 193 frames recorded on 3 sheets of microfiche, which are incorporated by reference.

A portion of the disclosure of this patent document contains material that is protected by copyright. The copyright owner has no objection to the facsimile reproduction of the patent document or the patent disclosure as it appears in the Patent and Trademark Office file or records, but otherwise reserves all copyright rights whatsoever.

For the convenience of the reader, the above description has focused on a representative sample of all possible embodiments, a sample that teaches the principles of the invention and conveys the best mode contemplated for carrying out the invention. The description has not attempted to exhaustively enumerate all possible variations. Further undescribed alternative embodiments are possible. It will be appreciated that many of those undescribed embodiments are within the literal scope of the following claims, and others are equivalent.

What is claimed:

1. A method, comprising the steps of:
among a cooperative consortium of manufacturers of a class of goods and a financing organization, cooperatively specifying underwriting standards for a class of financial instruments, the financing organization being cooperatively owned by at least three of the manufacturers, no single manufacturer owning 50% or more of the financing organization, rating agencies attributing to an originator of financial instruments of the class a moral recourse obligation to support the financial instruments;
originating financial instruments of the class, the financial instruments originated by a plurality of originators, including the manufacturers, and conforming to the underwriting standards, at least some of the financial instruments being originated at a below-market interest rate;
purchasing and aggregating financial instruments by the financing organization from the plurality of originators, the financing organization only purchasing financial instruments conforming to the underwriting standards, the financing organization not being bound to purchase all financial instruments tendered by the originators to the financing organization; and
offering the financial instruments for sale in the financial markets in the form of structured securities backed or secured by the financial instruments, the financial instruments being offered by the financing organization, the securities including a first loss piece and structured to entirely transfer default risk from the primary originators to purchasers and to terminate the moral recourse obligation of the originator.

2. A method, comprising the steps of:
offering financial instruments for sale in the financial markets, rating agencies attributing to an originator of the financial instruments a moral recourse obligation to support the financial instruments, the financial instruments being offered by a financing organization being chartered for the purpose of offering the financial instruments in the financial markets and offering the financial instruments on terms that entirely transfer default risk to purchasers of the financial instruments and that terminate the moral recourse obligation of the originator.

3. The method of claim 2, wherein:
the financial instruments are offered for sale in the financial markets in the form of structured securities backed or secured by the financial instruments, the securities including a first loss piece and structured to entirely transfer default risk to purchasers of the financial instruments and terminate the moral recourse obligation of the originator.

4. The method of claim 2, further comprising the step of:
aggregating financial instruments for sale in the financial markets, the financial instruments having been originated by a plurality of primary originators.

5. The method of claim 4, further comprising the step of:
ensuring that each pool of financial instruments offered for sale in the financial markets is diversified among the primary originators so that no single originator originated 50% or more of the financial instruments in the pool.

6. The method of claim 4, further comprising the step of:
offering the financial instruments in the financial markets in at least two forms drawn from the group consisting of: (a) whole financial instruments, (b) participations in pools of financial instruments, and (c) structured securities backed or secured by the financial instruments.

7. The method of claim 2, further comprising the step of:
aggregating for sale in the financial markets financial instruments originated by a plurality of primary originators, the financial instruments being offered by a financing organization cooperatively owned by at least three of the primary originators, no single originator of the ownership cooperative owning 50% or more of the financing organization.

8. The method of claim 2, wherein:
the financial instruments are purchase money financial instruments to finance purchase of an industry-recognized class of consumer goods offered by the originator or a corporate affiliate of the originator.

9. The method of claim 8, wherein the goods are automobiles.

10. The method of claim 8, wherein the originator is a captive finance company of an automobile manufacturer.

11. The method of claim 8, further comprising the step of:
adjusting a price paid by the financing organization to the originator based on depreciation rates or resale values of varying models of the goods.

12. The method of claim 2, further comprising the step of:
the originator contractually committing not to provide any form of credit support for financial instruments sold by the originator to the financing organization or by the financing organization in the financial markets.

13. The method of claim 2, further comprising the step of:
specifying underwriting standards for the financial instruments, the financing organization purchasing only financial instruments conforming to the underwriting standards, the underwriting standards excluding at least about 25% of originated financial instruments.

14. The method of claim 13, further comprising the step of:
developing the underwriting standards in consultation with the rating agencies.

15. A method, comprising the steps of:
offering securities for sale in the financial markets, the securities backed or secured by financial instruments, rating agencies attributing to an originator of the financial instruments a moral recourse obligation to support the financial instruments, the securities including a first loss piece and structured to entirely transfer default risk to purchasers of the financial instruments and terminate the moral recourse obligation of the originator.

16. The method of claim 15, wherein:
the financial instruments backing the securities were originated by a plurality of primary originators.

17. The method of claim 16, further comprising the step of:
ensuring that each security issue offered for sale is diversified among the primary originators so that no single originator originated 50% or more of the financial instruments backing the security issue.

18. The method of claim 16, further comprising the step of:
offering the financial instruments in the financial markets in at least two forms drawn from the group consisting of: (a) whole financial instruments, (b) participations in pools of the financial instruments, and (c) structured securities backed or secured by the financial instruments.

19. The method of claim 16, wherein:
the securities are offered by a financing organization cooperatively owned by at least three of the primary originators, no single originator of the ownership cooperative owning 50% or more of the financing organization.

20. The method of claim 19, further comprising the step of:
adjusting a price paid by the financing organization to the originators based on depreciation rates or resale values of goods financed by the financial instruments.

21. The method of claim 19, further comprising the step of:
adjusting a price paid by the financing organization to the originators based on average credit risk of borrowers of the financial instruments.

22. The method of claim 16, further comprising the step of:
specifying underwriting standards for a class of financial instruments, the underwriting standards being specified by a financing organization chartered to offer the securities; and
purchasing financial instruments by the financing organization from the plurality of originators of financial instruments, the financing organization purchasing only financial instruments conforming to the underwriting standards, the financing organization not being bound to purchase financial instruments tendered by the originators to the financing organization.

23. The method of claim 22, further comprising the step of:
specifying servicing standards for the financial instruments, the financing organization purchasing only financial instruments conforming to the servicing standards.

24. The method of claim 22, further comprising the step of:
developing the underwriting standards in consultation with the rating agencies.

25. The method of claim 15, wherein:
the financial instruments are drawn from an industry-recognized class of consumer financial instruments.

26. The method of claim 25, wherein the originator is a captive finance company of an automobile manufacturer.

27. The method of claim 15, further comprising the step of:
the originator contractually committing not to provide any form of credit support for financial instruments sold by the originator to the financing organization or by the financing organization in the financial markets.

28. The method of claim 15, wherein the securities comprise tranches of at least four seniorities.

29. A method, comprising the steps of:
aggregating and offering financial instruments for sale in the financial markets, the financial instruments having been originated by a plurality of primary originators, the financial instruments being offered by a financing organization on terms that entirely transfer default risk from the primary originators to purchasers of the financial instruments.

30. The method of claim 29, wherein:
the financing organization is cooperatively owned by at least three of the primary originators, no single originator of the ownership cooperative owning 50% or more of the financing organization.

31. The method of claim 30, wherein at least two members of the ownership cooperative are captive finance companies of automobile manufacturers.

32. The method of claim 30, wherein at least one of the primary originators is not a member of the ownership cooperative.

33. The method of claim 29, further comprising the step of:
specifying underwriting standards for a class of financial instruments, the underwriting standards being specified by the financing organization; and
purchasing financial instruments by the financing organization from the primary originators, the financing organization only purchasing financial instruments conforming to the underwriting standards, the financing organization not being bound to purchase financial instruments tendered by the originators to the financing organization.

34. The method of claim 29, wherein:
the originators are a cooperative consortium of manufacturers of a class of goods, who have agreed to underwriting standards for financial instruments to finance purchase of the goods; and
the financing organization purchases only financial instruments conforming to the underwriting standards.

35. The method of claim 29, further comprising the step of:
ensuring that each pool of financial instruments offered for sale in the financial markets is diversified among the primary originators so that no single originator originated 50% or more of the financial instruments in the pool.

36. The method of claim 29, wherein:
the financial instruments are purchase money financial instruments to finance purchase of an industry-recognized class of consumer goods offered by the originator or by a corporate affiliate of the originator.

37. The method of claim 29, wherein:
the financial instruments are drawn from an industry-recognized class of consumer financial instruments.

38. The method of claim 29, further comprising the step of:
adjusting a price paid by the financing organization to the originator based on depreciation rates or resale values of varying models of the goods.

39. The method of claim 29, further comprising the step of:
the originator contractually committing not to provide any form of credit support for financial instruments sold by the originators to the financing organization or by the financing organization in the financial markets.

40. The method of claim 29, further comprising the step of:
offering the financial instruments in the financial markets in at least two forms drawn from the group consisting of: (a) whole financial instruments, (b) participations in pools of the financial instruments, and (c) structured securities backed or secured by the financial instruments.

41. The method of claim 29, further comprising the step of:
organizing the financial instruments into pools for sale in the financial markets, the financial instruments backing each pool being held by a bankruptcy-remote entity established by the financing organization.

42. The method of claim 29, wherein the financial instruments are offered in the financial markets in the form of structured securities of at least four seniority tranches.

43. The method of claim 29, further comprising the step of:
adjusting a price paid by the financing organization to the originators based on average credit risk of borrowers of the financial instruments.

44. The method of claim 29, further comprising the step of:
specifying servicing standards for the financial instruments, the financing organization purchasing only financial instruments conforming to the servicing standards.

45. A method, comprising the steps of:
aggregating and offering financial instruments for sale in the financial markets, the financial instruments having been originated by a plurality of primary originators, the financial instruments being offered by a financing organization cooperatively owned by at least three of the primary originators, no single originator of the ownership cooperative owning 50% or more of the financing organization.

46. The method of claim 45, wherein:
the financial instruments conform to underwriting standards specified by the financing organization, the financing organization not being bound to purchase financial instruments tendered by the originators to the financing organization.

47. The method of claim 46, further comprising the step of:
the financing organization re-underwriting the financial instruments to ensure compliance with the underwriting standards.

48. The method of claim 45, further comprising the step of:
the financial instruments conform to underwriting standards specified by a cooperative consortium of manufacturers of a class of goods, the financial instruments being purchase money financial instruments to finance purchase of the goods.

49. The method of claim 48, further comprising the step of:
the financing organization auditing the financial instruments for compliance with the underwriting standards.

50. The method of claim 45:
wherein the financial instruments have been originated at a below-market interest rate,
and further comprising the step of the financing organization purchasing the financial instruments receiving a cash payment from either a manufacturer of goods financed by the financial instruments or from the originators, the payment being in an amount compensating for the below-market rate.

51. The method of claim 45, wherein:
the financial instruments are purchase money financial instruments to finance purchase of a class of consumer goods offered by the originators or by corporate affiliates of the originators.

52. The method of claim 45, wherein at least two members of the ownership cooperative are captive finance companies of automobile manufacturers.

53. The method of claim 45, further comprising the step of:
ensuring that each pool of financial instruments aggregated and offered for sale is diversified among the primary originators so that no single originator originated 50% or more of the financial instruments in the pool.

54. The method of claim 45, wherein at least one of the primary originators is not a member of the ownership cooperative.

55. The method of claim 45, further comprising the step of:
the originators contractually committing not to provide any form of credit support for financial instruments sold by the originators to the financing organization or by the financing organization in the financial markets.

56. The method of claim 45, further comprising the step of:
aggregating the financial instruments into pools for sale in the financial markets, the financial instruments backing each pool being held by a bankruptcy-remote entity established by the financing organization.

57. The method of claim 45, further comprising the step of:
adjusting a price paid by the financing organization to the originators based on average credit risk of borrowers of the financial instruments.

58. The method of claim 45, further comprising the step of:
specifying servicing standards for the financial instruments, the financing organization purchasing only financial instruments conforming to the servicing standards.

59. A method, comprising the steps of:
specifying underwriting standards for a class of financial instruments, the underwriting standards being specified by a financing organization chartered to offer financial instruments conforming to the underwriting standards in the financial markets; and
purchasing financial instruments by the financing organization from a plurality of originators of financial instruments, the financing organization only purchasing financial instruments conforming to the underwriting standards, the financing organization not being bound to purchase financial instruments tendered by the originators to the financing organization.

60. The method of claim 59, wherein:
the underwriting standards are specified in consultation with members of a cooperative consortium of manufacturers of a class of goods, the financial instruments being purchase money financial instruments to finance purchase of the goods.

61. The method of claim 60, further comprising the step of:
the financing organization auditing the financial instruments for compliance with the underwriting standards.

62. The method of claim 59, further comprising the step of:
wherein the financial instruments have been originated at a below-market interest rate, the financing organization receiving a cash payment from either a manufacturer of goods financed by the financial instruments or from the originators, the payment being in an amount compensating for the below-market rate.

63. The method of claim 59:
wherein rating agencies attribute to the originators a moral recourse obligation to support the financial instruments.

64. The method of claim 63, further comprising the step of:
offering the financial instruments in the financial markets on terms that entirely transfer default risk to purchasers of the financial instruments and that terminate the moral recourse obligation of the originators.

65. The method of claim 63, further comprising the step of:
developing the underwriting standards in consultation with the rating agencies.

66. The method of claim 59, further comprising the step of:
entering a master servicing agreement among the financing organization and the originators under which a master servicing entity provides master servicing services.

67. The method of claim 59, further comprising the step of:
organizing the financial instruments into pools for sale in the financial markets.

68. The method of claim 67, further comprising the step of:
ensuring that each pool of financial instruments offered for sale in the financial markets is diversified among the primary originators so that no single originator originated 50% or more of the financial instruments in the pool.

69. The method of claim 67, further comprising the step of:
transferring ownership of the financial instruments backing each pool into a bankruptcy-remote entity established by the financing organization.

70. The method of claim 59, further comprising the step of:
the financing organization re-underwriting the financial instruments to ensure compliance with the underwriting standards.

71. The method of claim 59, further comprising the step of:
adjusting a price paid by the financing organization to an originator based on average credit risk of borrowers of the financial instruments offered by the originator.

72. The method of claim 59, further comprising the step of:
specifying servicing standards for the financial instruments, the financing organization purchasing only financial instruments conforming to the servicing standards.

73. A method, comprising the steps of:
among a cooperative consortium of originators of financial instruments, agreeing to underwriting standards for financial instruments; and
aggregating financial instruments for offering in the financial markets, the financial instruments originated by the originators and conforming to the underwriting standards.

74. The method of claim 73, wherein at least two of the originators are captive finance companies of automobile manufacturers.

75. The method of claim 73, wherein:
the aggregating of the financial instruments is performed by a financing organization that is independent of the originators.

76. The method of claim 75, wherein:
the financial instruments have been originated at a below-market interest rate, and the financing organization has received a cash payment from either a manufacturer of goods financed by the financial instruments or from the originators, the payment being in an amount compensating for the below-market rate.

77. The method of claim 75, further comprising the step of:
entering a master servicing agreement among the financing organization and the originators under which a master servicing entity provides master servicing services.

78. The method of claim 75, further comprising the step of:
re-underwriting the financial instruments by the financing organization to ensure compliance with the underwriting standards.

79. The method of claim 75, further comprising the step of:
adjusting a price paid by the financing organization to an originator based on average credit risk of the financial instruments offered by the originator.

80. The method of claim 75, further comprising the step of:
adjusting a price paid by the financing organization to the originators based on depreciation rates or resale values of varying models of the goods.

81. The method of claim 75, further comprising the step of:
specifying servicing standards for the financial instruments, the financing organization purchasing only financial instruments conforming to the servicing standards.

82. The method of claim 75, further comprising the step of:
the originators contractually committing not to provide any form of credit support for financial instruments sold by the originators to the financing organization or by the financing organization in the financial markets.

83. The method of claim 73, wherein:
rating agencies attribute to originators of the financial instruments a moral recourse obligation to support the financial instruments.

84. The method of claim 83, further comprising the step of:
offering the financial instruments in the financial markets on terms that entirely transfer default risk to purchasers of the financial instruments and that terminate the moral recourse obligation of the originators.

85. The method of claim 73, further comprising the step of:
offering the financial instruments in the financial markets in the form of structured securities backed or secured by the financial instruments, the securities including a first loss piece and structured to entirely transfer default risk to purchasers of the financial instruments and terminate the moral recourse obligation of the originators.

86. The method of claim 73, further comprising the step of:
developing the underwriting standards in consultation with the rating agencies.

87. The method of claim 73, further comprising the step of:
organizing the financial instruments into pools for sale in the financial markets.

88. The method of claim 87, further comprising the step of:
ensuring that each pool of financial instruments offered for sale in the financial markets is diversified among the primary originators so that no single originator originated 50% or more of the financial instruments in the pool.

89. The method of claim 87, further comprising the step of:
transferring ownership of the financial instruments backing each pool into a bankruptcy-remote entity established by a financing organization that is independent of the originators.

90. The method of claim 87, wherein the pools are offered in the financial markets in the form of structured securities of at least three seniority tranches.

91. The method of claim 73, wherein at least one of the primary originators is not a member of the ownership cooperative.

92. A method, comprising the steps of:
purchasing financial instruments from a plurality of originators of financial instruments, the financial instruments having been originated at a below-market interest rate, a financing organization purchasing the financial instruments receiving a cash payment from either a manufacturer of goods financed by the financial instruments or from the originators, the payment being in an amount compensating for the below-market rate.

93. The method of claim 92, wherein at least two of the originators are captive finance companies of automobile manufacturers.

94. The method of claim 92, wherein: rating agencies attribute to the originators a moral recourse obligation to support the financial instruments.

95. The method of claim 94, further comprising the step of:
offering the financial instruments for sale in the financial markets, on terms that entirely transfer default risk to purchasers of the financial instruments and that terminate the moral recourse obligation of the originators.

96. The method of claim 94, further comprising the step of:
offering the financial instruments for sale in the financial markets in the form of structured securities backed or secured by the financial instruments, the securities including a first loss piece and structured to entirely transfer default risk to purchasers of the financial instruments and terminate the moral recourse obligation of the originator.

97. The method of claim 92, further comprising the step of:
aggregating and offering the financial instruments for sale in the financial markets, the financial instruments being offered by a financing organization on terms that entirely transfer default risk from the primary originators to purchasers of the financial instruments.
